(19) United States
(12) Patent Application Publication
(10) Pub. No.: US 2019/0095092 A1
(43) Pub. Date: Mar. 28, 2019

(54) METHOD, APPARATUS AND COMPUTER PROGRAM FOR CONTROLLING A VEHICLE

(71) Applicant: Jaguar Land Rover Limited, Whitley, Coventry, Warwickshire (GB)

(72) Inventors: Dion THOMAS, Whitley, Coventry (GB); Stuart WHITE, Whitley, Coventry (GB); Rebecca WILDE, Whitley, Coventry (GB); Jerciline GNANASUNDARAPAULRAJ, Whitley, Coventry (GB); Martin SMITH, Whitley, Coventry (GB)

(73) Assignee: Jaguar Land Rover Limited, Whitley, Coventry, Warwickshire (GB)

(21) Appl. No.: 16/083,426

(22) PCT Filed: Mar. 1, 2017
(86) PCT No.: PCT/EP2017/054706

§ 371 Date: Sep. 7, 2018

(30) Foreign Application Priority Data
Mar. 15, 2016 (GB) 1604403.4

(51) Int. Cl. G06F 3/0488; B60K 35/00; G06F 3/0484

(52) U.S. Cl. CPC G06F 3/04883; B60K 35/00; G06F 3/0484; G06F 3/0482; B60K 2350/1024; B60K 2350/928; G06F 2203/04808; B60K 2350/1052

(57) ABSTRACT

A method, apparatus (11), vehicle (1), and computer program for detecting user inputs for controlling a vehicle (1). The method comprising: detecting a combination user input where the combination user input comprises a first gesture input detected by a first means for detecting user inputs and a second gesture input detected by a second means for detecting user inputs wherein the first means for detecting user inputs and the second means for detecting user inputs are provided on a steering wheel (3) of the vehicle (1); and enabling a function associated with the combination user input to be performed.

### TECHNICAL FIELD

The present disclosure relates to a method, apparatus and computer program for controlling a vehicle. In particular, but not exclusively it relates to an apparatus, method and computer program for controlling user interfaces within a vehicle.

Aspects of the invention relate to a method, apparatus, computer program and vehicle.

### BACKGROUND

User interfaces within vehicles enable drivers to interact with control systems within the vehicle. For instance they may enable a user to access menu systems and control applications and systems that they can access within the menu systems. The user interfaces may enable the user to control navigation applications, entertainment applications or any other suitable applications.

It is an aim of the present invention to improve user interfaces within vehicles.

### SUMMARY OF THE INVENTION

Aspects and embodiments of the invention provide a method, apparatus, computer program and vehicle as claimed in the appended claims.

According to an aspect of the invention there is provided a method of detecting user inputs for controlling a vehicle, the method comprising: detecting a combination user input where the combination user input comprises a first gesture input detected by a first means for detecting user inputs and a second gesture input detected by a second means for detecting user inputs wherein the first means for detecting user inputs and the second means for detecting user inputs are provided on a steering wheel of the vehicle; and enabling a function associated with the combination user input to be performed.

Examples of the disclosure provide a user interface within a steering wheel which can detect combination user inputs comprising a plurality of gestures. The combination user input could be a multi touch user input or any other suitable user input. The combination user inputs could be simple and intuitive for a user to make which provides a user interface which is easy for a user to control while they are driving. Embodiments of the invention use a plurality of different means for detecting the user inputs. This may increase the number of user inputs that are available to control a user interface which may increase the number of functions that can be accessed and controlled through the user interface. Using a plurality of different means for detecting user inputs may also reduce the number of accidental actuations or inputs as a user may be less likely to accidentally actuate two means for detecting user inputs.

The first gesture input and the second gesture input may be detected simultaneously.

This may provide the advantage that it enables combination inputs such as multi touch inputs to be made. This may enable intuitive gesture inputs such as pinching movements to be detected. This may increase the number of different types of user inputs that can be used to control the user interface. Having a wider variety of inputs may reduce the likelihood of an incorrect actuation being made as it may be easier for controller to disambiguate between the different user inputs.

The first gesture input and the second gesture input may be detected sequentially.

This may provide the advantage that it may increase the number of different types of user inputs that the user interface can detect. There may be any number of sequences of different user inputs that can be detected by the user interface. Different sequences may be associated with different functions.

At least one of the means for detecting user inputs may be located on the front of the steering wheel.

Having means for detecting user inputs located on the front of the steering wheel may provide the advantage that the driver can easily actuate the means for detecting gesture inputs when they are driving the vehicle. This provides a user interface which is convenient for a driver to use while they are driving. Having the means for detecting gesture inputs located on the front of the steering wheel may also enable the driver to easily view any icons or other information that is displayed on the means for detecting gesture inputs.

At least one of the means for detecting user inputs may be located on the rear of the steering wheel.

This provides the advantage that the rear of the steering wheel may provide an area which enables user inputs. This increases the area available for making user inputs and so may increase the functionality of the user interface. As the means for detecting the user inputs is located on the rear of the steering wheel the user could actuate this area with their fingers when they are holding the steering wheel. Some users may find inputs made in this way easier or more comfortable to make.

At least one of the means for detecting user inputs may be located on the steering wheel and arranged to rotate about the steering column axis.

This may ensure that the means for detecting gesture inputs are always positioned so that they can be easily actuated by the user. This may make the user interface easier for a driver to use while they are driving.

The method may comprise disabling at least one of the means for detecting user inputs if it is detected that the steering wheel has been rotated though an angle greater than a threshold angle. Additionally or alternatively, the method may comprise disabling at least one of the means for detecting user inputs if it is detected that the steering wheel has been rotated at a rate greater than a threshold rate. For example, the method may comprise disabling at least one of the means for detecting user inputs if it is detected that the rate of change of an angular position of the steering wheel is above a threshold rate.

This may prevent the user accidentally actuating the means for detecting user inputs when they are performing manoeuvres such as parking the vehicle.

The function that is performed may be dependent on a current mode of operation of a user interface.

This may enable the same means for detecting gesture inputs to be used to control different functions. This may provide a versatile user interface that can be used to control a plurality of systems within a vehicle.

The function that is performed may comprise controlling information displayed on a display.

This may enable the user to control the information that is provided to them. This allows the user to select the information they want and enable this information to be displayed in a preferred format. This may improve the user interface for the driver and may provide fewer distractions for them when they are driving.

The function that is performed may comprise navigating through a menu structure.

The use of the combination inputs may enable different inputs to be made to scroll through menu levels and to select items from the menu levels. This may enable the user interface to be used to access a plurality of different applications. The user inputs that are required to navigate through the menu structure may comprise gesture inputs that are simple and intuitive for a driver to make.

At least one of the means for detecting user inputs may comprise a touch sensitive device.

This may provide the advantage that the user inputs may comprise touch inputs which are easy for a user to make whilst driving.

At least one of the means for detecting user inputs may comprise an infrared sensor device.

The infrared device may provide the advantage that it may enable different types of the gesture inputs to be detected. For example it may be configured to detect touch inputs or movement of the driver's fingers or thumbs or any other suitable types of user inputs. The infrared device may also enable the driver to make user inputs while wearing gloves.

According to an aspect of the invention there is provided an apparatus for detecting user inputs for controlling a vehicle, the apparatus comprising: means for detecting a combination user input where the combination user input comprises a first gesture input detected by a first means for detecting user inputs and a second gesture input detected by a second means for detecting user inputs wherein the first means for detecting user inputs and the second means for detecting user inputs are provided on a steering wheel of the vehicle; and means for enabling a function associated with the combination user input to be performed.

According to an aspect of the invention there is provided an apparatus comprising means for enabling any of the methods described above.

According to an aspect of the invention there is provided a vehicle comprising an apparatus as described above.

According to an aspect of the invention there is provided a computer program for detecting user inputs for controlling a vehicle, the computer program comprising instructions that, when executed by one or more processors, cause an apparatus to perform, at least: detecting a combination user input where the combination user input comprises a first gesture input detected by a first means for detecting user inputs and a second gesture input detected by a second means for detecting user inputs wherein the first means for detecting user inputs and the second means for detecting user inputs are provided on a steering wheel of the vehicle; and enabling a function associated with the combination user input to be performed.

According to an aspect of the invention there is provided a non-transitory computer readable media comprising a computer program as described above.

According to an aspect of the invention there is provided a system for detecting user inputs for controlling a vehicle, the system comprising:
means for receiving one or more signals each indicative of a gesture user input;
means to detect a combination user input based on the one or more signals each indicative of a gesture user input; and
means to control a function of the vehicle by enabling a function associated with the combination user input to be performed.

According to an aspect of the invention there is provided a system for as described above, wherein:
said means for receiving one or more signals each indicative of a gesture user input comprises an electronic processor having an electrical input for receiving said one or more signals each indicative of a gesture user input; and
an electronic memory device electrically coupled to the electronic processor and having instructions stored therein,
said means to detect a combination user input based on the one or more signals each indicative of a gesture user input, and said means to control a function of the vehicle by enabling a function associated with the combination user input to be performed comprises the processor being configured to access the memory device and execute the instructions stored therein such that it is operable to detect a combination user input based on the one or more signals; and command control of a function of the vehicle by enabling a function associated with the combination user input to be performed.

According to an aspect of the invention there is provided an apparatus for controlling a vehicle comprising a steering wheel and a plurality of means for detecting gesture user inputs where the means for detecting gesture user inputs are located on spokes of a steering wheel.

According to an aspect of the invention there is provided a method of detecting user inputs for controlling a vehicle, the method comprising: detecting a gesture user input wherein the gesture user input comprises a user actuating a means for detecting user inputs located on the rear of a steering wheel; and enabling a function associated with gesture user input to be performed.

The apparatus may be for providing a user interface within a vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates a vehicle;

FIG. 2 illustrates an apparatus;

FIG. 3 illustrates an example apparatus within a system;

FIG. 4 illustrates an example user interface;

FIG. 5 illustrates an example user interface

FIG. 6 illustrates an example method; and

FIG. 7 illustrates another example method.

### DETAILED DESCRIPTION

The Figures illustrate a method of detecting user inputs for controlling a vehicle 1. The method comprises: detecting a combination user input where the combination user input comprises a first gesture input detected by a first means 37A for detecting user inputs and a second gesture input detected by a second means 37B for detecting user inputs wherein the first means 37A for detecting user inputs and the second means 37B for detecting user inputs are provided on a steering wheel 3 of the vehicle 1; and enabling a function associated with the combination user input to be performed.

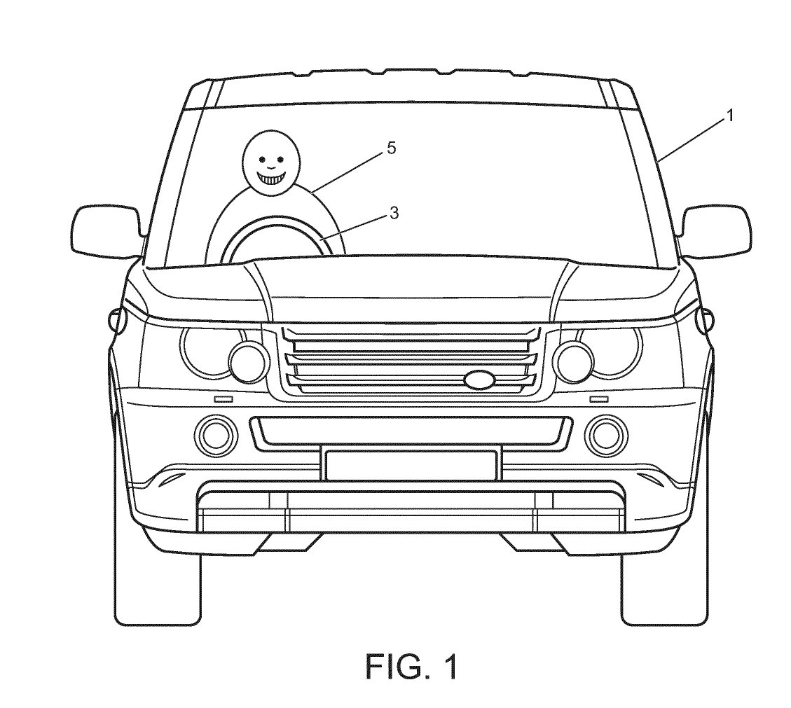

FIG. 1 illustrates an example vehicle 1 which may comprise apparatus 11 according to examples of the present disclosure. The vehicle 1 comprises a user interface 35 which may be controlled by the apparatus 11 to perform methods of detecting user inputs as described below. The methods may enable control of one or more systems or applications of a vehicle 1. The methods and apparatus 11 may enable control of functions and features of the vehicle 1 from the steering wheel 3 of the vehicle 1. The functions and features that are controlled may be functions relating to applications of the vehicle rather than the steering of the vehicle. In some examples the functions that are controlled may be external to the vehicle, for instance they may relate exterior features of a vehicle 1 such as the positions of wing mirrors. Example apparatus 11 and user interfaces 35 are described below.

The vehicle 1 comprises a steering wheel 3 which may be used by the driver 5 to steer the vehicle 1. The example user interfaces 35 may comprise means 37 for detecting user inputs which are located on or around the steering wheel 3. Embodiments of the invention may enable the user to make user inputs such as gesture user inputs while they are holding the steering wheel 3.

It is to be appreciated that the vehicle 1 of FIG. 1 is illustrated as an example and that embodiments of the invention may be provided in any suitable vehicle 1.

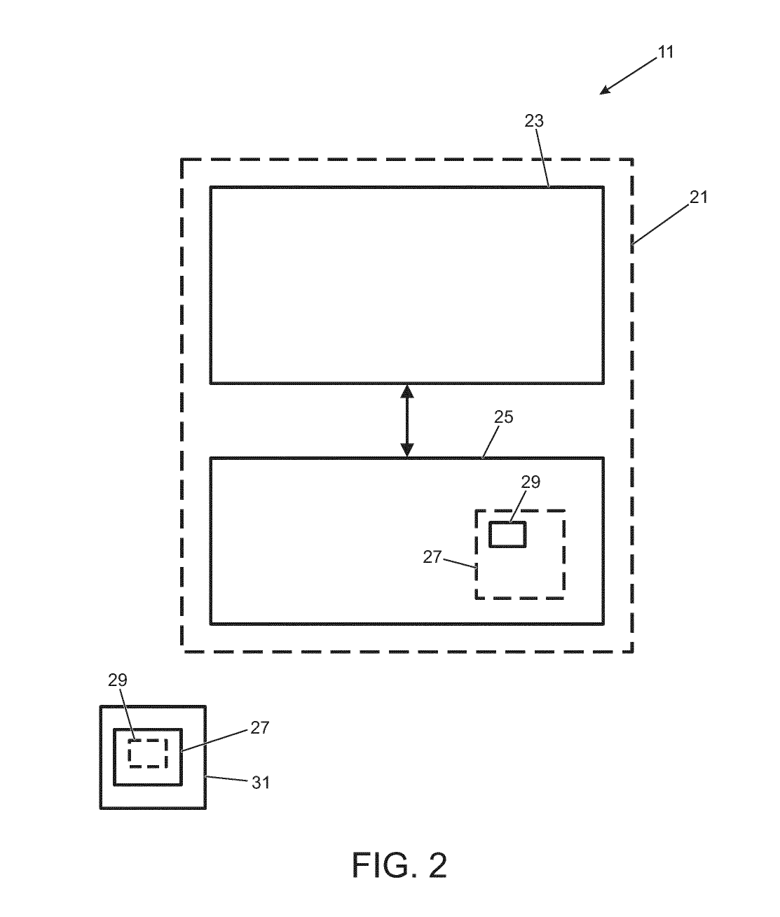

FIG. 2 illustrates an example apparatus 11 which may be used to control a user interface 35 within the vehicle 1. The apparatus 11 may enable user inputs such as gesture user inputs to be detected. The apparatus 11 may also enable a function corresponding to the detected user input to be performed. In some examples the function may be performed by the apparatus 11. In other examples the apparatus 11 may be arranged to send a control signal to another apparatus or device to enable the function to be performed.

The apparatus 11 comprises a controller 21. The controller 21 may be a chip or a chip set. The controller 21 may form part of one or more systems 33 comprised in the vehicle 1. The controller 21 may be arranged to control any suitable functions of applications within the vehicle 1. In embodiments of the invention the controller 21 may be arranged to control a user interface 35 within the vehicle 1. Example user interfaces 35 which may be controlled by the controller 21 are described below.

The controller 21 comprises at least one processor 23, at least one memory 25 and at least one computer program 27.

Implementation of a controller 21 may be as controller circuitry. The controller 21 may be implemented in hardware alone, may have certain aspects in software including firmware alone or may be a combination of hardware and software (including firmware).

As illustrated in FIG. 2 the controller 21 may be implemented using instructions that enable hardware functionality, for example, by using executable instructions of a computer program 27 in a general-purpose or special-purpose processor 23 that may be stored on a computer readable storage medium (disk, memory etc) to be executed by such a processor 23.

The processor 23 may be arranged to read from and write to the memory 25. The processor 23 may also comprise an output interface via which data and/or commands are output by the processor 23 and an input interface via which data and/or commands are input to the processor 23.

The memory 25 may be arranged to store a computer program 27 comprising computer program instructions 29 (computer program code) that controls the operation of the controller 21 when loaded into the processor 23. The computer program instructions 29, of the computer program 27, provide the logic and routines that enables the controller 21 to detect gesture user inputs made by a user actuating one or more means for detecting gesture user inputs. The controller 21 may also enable information to be provided to the user. The controller 21 may also enable functions to be reformed by systems and/or applications within the vehicle 1.The processor 23 by reading the memory 25 is able to load and execute the computer program 27.

As illustrated in FIG. 2, the computer program 27 may arrive at the controller 21 via any suitable delivery mechanism 31. The delivery mechanism 31 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 27. The delivery mechanism may be a signal arranged to reliably transfer the computer program 27. The controller 21 may propagate or transmit the computer program 27 as a computer data signal.

Although the memory 25 is illustrated as a single component/circuitry it may be implemented as one or more separate components/circuitry some or all of which may be integrated/removable and/or may provide permanent/semi-permanent/dynamic/cached storage.

Although the processor 23 is illustrated as a single component/circuitry it may be implemented as one or more separate components/circuitry some or all of which may be integrated/removable. The processor 23 may be a single core or multi-core processor.

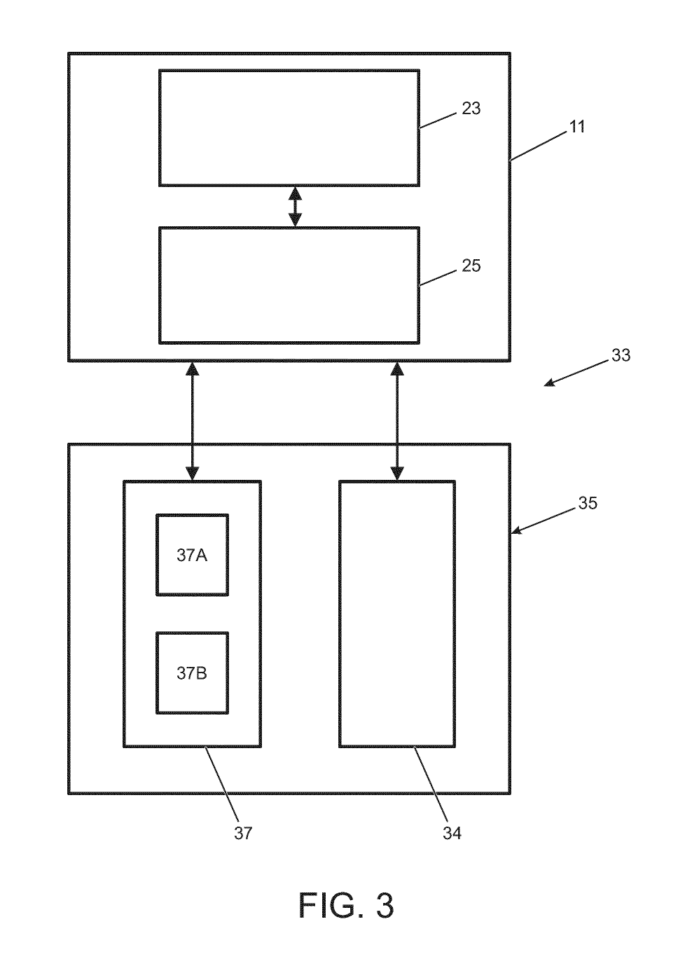

FIG. 3 schematically illustrates an example apparatus 11 within a system 33. The system 33 may be provided within the vehicle 1. The system 33 comprises an apparatus 11 and a user interface 35. The system 33 may enable the apparatus 11 to control the user interface 35.

The apparatus 11 may comprise one or more processors 23 and memory 25 as described above. The apparatus 11 may provide means for controlling the user interface 35. The apparatus 11 may be arranged to detect user inputs by detecting signals received from the user interface 35. In response to detecting the user inputs the apparatus 11 may enable a corresponding function to be performed.

The user interface 35 may comprise any means which enables a driver 5 to interact with the systems within the vehicle 1. In the example system of FIG. 3 the user interface 35 comprises a plurality of means 37 for detecting user inputs and at least one means 39 for providing outputs to the driver 5.

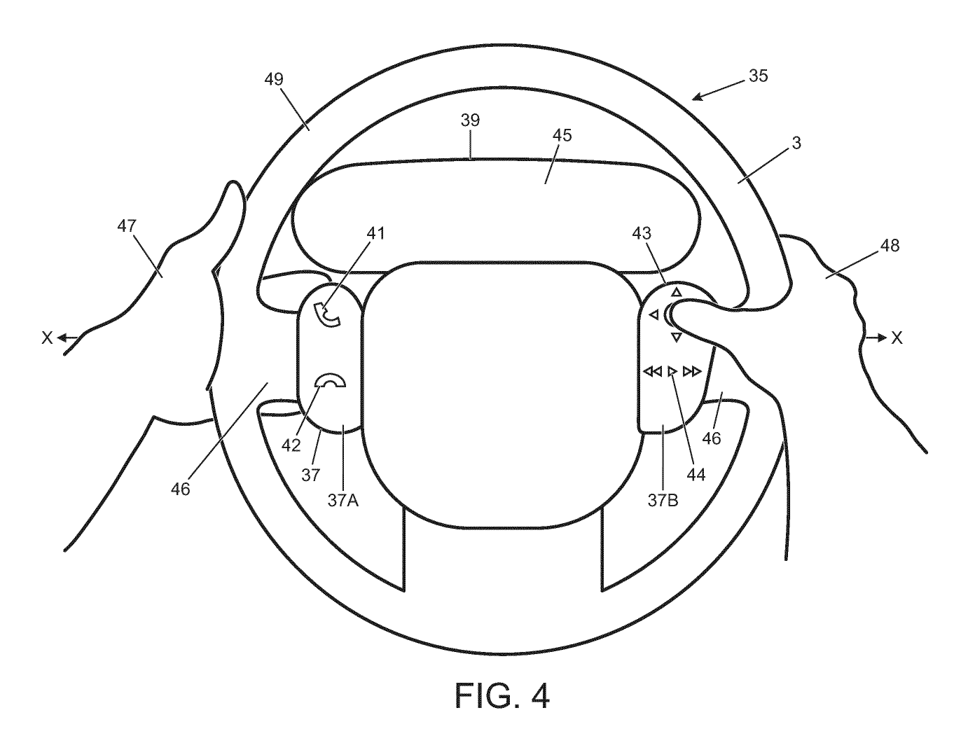

The means 37 for detecting user inputs may comprise any means which enables the driver 5 to provide an input to the apparatus 11. The means 37 for detecting the user inputs may be located within the vehicle 1 so that they are easily accessible for the driver 5. In some embodiments of the invention at least some of the means 37 for detecting user inputs may be located on the steering wheel 3. Examples of means 37 for detecting user inputs which are located on steering wheel 3 are shown in FIG. 4.

The means 37 for detecting user inputs may be arranged to detect gesture inputs. The gesture inputs may comprise a parameter of the driver's hands or a change in a parameter of the driver's hands which is detected by the means 37 for detecting user inputs. The parameters of the driver's hands could be the positions of one or more digits, movement of one or more digits, a sequence of movements of one or digits, the time for which a digit is held in a particular position or any other suitable parameters.

The means 37 for detecting user inputs may comprise any suitable types of user input devices. In some examples the plurality of means 37 for detecting user inputs may comprise a plurality of different types of user input devices.

In some examples the means 37 for detecting user inputs may comprise a touch sensitive device. The touch sensitive device may comprise a surface which is arranged to provide an output signal when the driver 5 touches the surface. The signal may indicate the location on the surface that the driver 5 has touched. The touch sensitive device may be arranged to detect when the driver's digits are touching the surface. In some examples the touch sensitive device may be arranged to detect when the driver's digits are in close proximity to the surface. For instance the touch sensitive device may also be configured to detect hover inputs which may comprise a driver 5 bringing a finger or other digit close to the surface of the touch sensitive device without actually touching the touch sensitive device.

The touch sensitive device may be arranged to detect different types of gesture inputs. For instance the touch sensitive device may be arranged to detect movements of fingers or other digits such as swiping gestures. In some examples the touch sensitive device may be arranged to detect gesture inputs such as double taps or multi-touch inputs. In some examples the touch sensitive device may be arranged to determine the time for which a gesture user input is made. This may enable the apparatus 11 to distinguish between short press and long press user inputs. In some examples the touch sensitive surface may be arranged to detect a magnitude of the force with which the driver 5 is touching the surface. This may enable the apparatus 11 to distinguish between light presses and hard presses.

The touch sensitive device could comprise any suitable type of touch sensitive device. For instance, the touch sensitive device could comprise a capacitive touch pad, a resistive touch pad, an infrared sensor device or any other suitable type of touch sensor device.

In some examples the touch sensitive device may comprise a touch sensitive display which may be arranged to display information to the driver 5. In such examples the means 37 for detecting user inputs may be integrated with means 39 for providing information to the driver 5. The information that is displayed on the touch sensitive device could comprise information indicative of the functions that are accessible via the user interface 35, indications of the areas of the means 37 for detecting user inputs that can be actuated or any other suitable information.

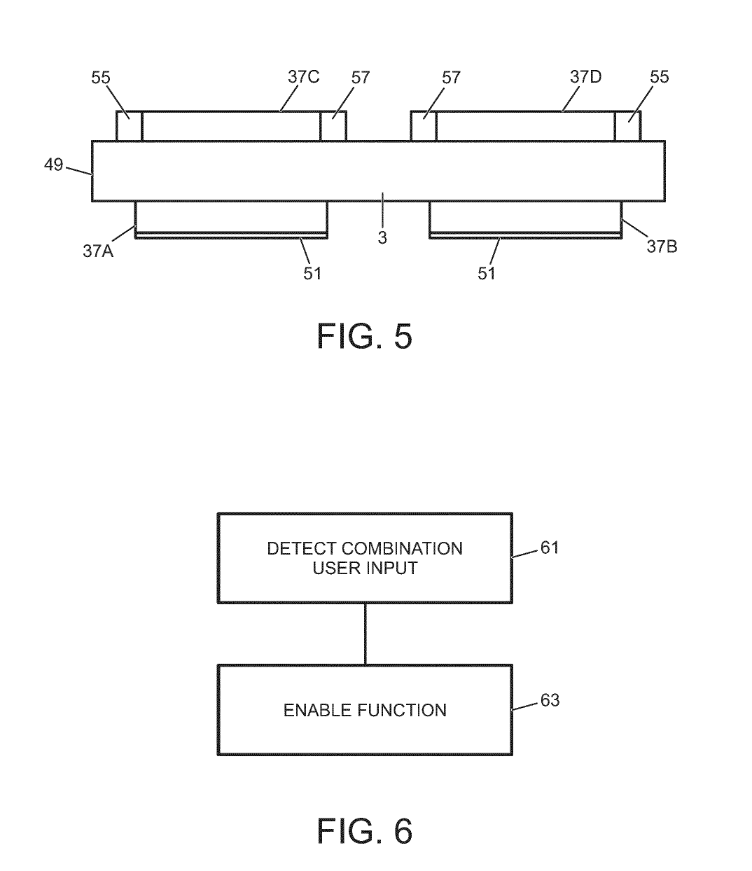

The user interface 35 comprises a plurality of means 37 for detecting user inputs. The different means 37 for detecting user inputs may be located at different positions within the vehicle 1. The different means 37 for detecting user inputs may be located at different positions around the steering wheel 3. FIGS. 4 and 5 show example locations of different means 37 for detecting user inputs. It is to be appreciated that other arrangements may be used in other examples of the disclosure.

In the example of FIG. 3 two means 37 for detecting user inputs are provided. The plurality of means 37 for detecting user inputs comprises a first means 37A for detecting user inputs and a second means 37B for detecting user inputs. It is to be appreciated that any number of means 37 for detecting user inputs may be provided in other examples of the disclosure.

In some examples different means 37 for detecting user inputs may be arranged to enable different functions to be performed. The different functions could be associated with applications and/or systems within the vehicle 1. For instance, the first means 37A for detecting user inputs may be arranged to enable access to functions relating to a communications applications while the second means 37B for detecting user inputs may be arranged to enable access to functions relating to entertainment applications or navigation applications.

The plurality of means 37 for detecting user inputs may enable combination user inputs to be detected by the apparatus 11. A combination user input may comprise a first gesture input detected by a first means 37A for detecting user inputs and a second gesture input detected by a second means 37B for detecting user inputs. The first and second gesture inputs could be any suitable types of gesture inputs. For instance the gesture user input may comprise a driver touching a specific portion of a surface or moving their digits in a particular direction or sequence or any other suitable type of gesture input.

In some examples the gesture input may comprise making a non-contact gesture. In such examples the driver does not need to physically touch the surface but may just bring their digits or other parts of their hand to a location close to the surface.

In some examples the system 33 may be arranged to enable the different gesture user inputs to be detected simultaneously. This may enable multi-touch gesture user inputs such as pinching to be detected. The different parts of the pinching movements could be detected by different means 37 for detecting user inputs. The gesture user inputs may be simple and intuitive for the driver 5 to make.

In some examples the system 33 may be arranged to enable the different gesture user inputs to be detected sequentially. The apparatus 11 may be arranged to detect particular sequences of user inputs and associate these with specific functions or applications.

The user interface 35 also comprises means 39 for providing information to the driver 5. The apparatus 11 may be arranged to control the information that is provided.

In some examples the means 39 for providing information to the driver 5 may comprise one or more displays. The one or more displays may comprise any suitable display. In some examples a display 45 may be provided in the dashboard of the vehicle 1. In some examples the one or more displays could comprise a heads up display unit. The head up display unit may be arranged so that the driver 5 can view information displayed on the head up display unit without diverting their attention from the road. In some examples the one or more displays could comprise a touch sensitive display which could be integrated with the means 37 for detecting user inputs as described above.

In some examples the means 39 for providing information to the driver 5 may comprise audio output means. For example one or more loudspeakers may be arranged within the vehicle 1 to provide audio signals for the driver 5.

It is to be appreciated that other means 39 for providing information to the driver 5 may be used in other embodiments of the invention. For instance, in some examples the means 39 for providing information to the driver 5 could comprise means for providing tactile feedback to the driver 5. The tactile feedback may comprise any feedback that the driver 5 can sense through the sense of touch. The tactile feedback could comprise a vibration of the steering wheel or a change in shape of a surface of means 37 for detecting user inputs or any other suitable tactile feedback. This tactile feedback could provide an indication to the driver 5 that a user input has been detected or that a selection has been made or any other suitable information.

FIG. 4 illustrates an example user interface 35 according to embodiments of the invention. In the examples of FIG. 4 the example user interface 35 comprises a plurality of means 37 for detecting user inputs and means 39 for providing information to the driver 5. The vehicle 1 may also comprise an apparatus 11 for controlling the user interface 35. The apparatus 11 may be provided in any suitable location within the vehicle 1 and is not illustrated in FIG. 4.

In the example user interface 35 of FIG. 4 some of the means 37 for detecting user inputs are located on the front of the steering wheel 3. In the example of FIG. 4 two means 37 for detecting user inputs are located on the front of the steering wheel 3. In the example of FIG. 4 a first means 37A for detecting user inputs is located on the left hand side of the front of the steering wheel 3 and a second means 37B for detecting user inputs is located on the right hand side of the front of the steering wheel 3. The means 37 for detecting user inputs may be arranged so that the driver can actuate the first means 37A for detecting user inputs with their left hand 47 and the second means 37B for detecting user inputs with their right hand 38.

The means 37 for detecting user inputs that are located on the front of the steering wheel 3 may be viewed by the driver 5. This may enable the driver 5 to view information that is displayed on the means 37 for detecting user inputs.

In the example of FIG. 4 the first means 37A for detecting user inputs and also the second means 37B for detecting user inputs comprise touch sensitive displays. The driver 5 may actuate the first means 37A for detecting user inputs and the second means for detecting user inputs by touching the surfaces of the respective means 37A, 37B for detecting user inputs with one or more of their digits.

In the example of FIG. 4 the touch sensitive displays are arranged to display icons 41, 42, 43, 44. The icons 41, 42, 43, 44 may represent functions that would be performed if the driver 5 actuates the area of the touch sensitive display in which the icon 41, 42, 43, 44 is displayed. The icons 41, 42, 43, 44 that are displayed may be dependent upon the mode of the operation of the user interface 35. The apparatus 11 may control the touch sensitive displays to display different icons 41, 42, 43, 44 in dependence on the mode of operation of the user interface 35. The mode of operation of the user interface may be dependent on the functions that are currently being accessed by the driver of the vehicle 1.

The apparatus 11 may control the touch sensitive display so that the icons 41, 42, 43, 44 may be positioned in a location that is easy for the driver 5 to reach. In some examples the icons may be positioned so that the driver 5 can actuate the icons 41, 42, 43, 44 with their thumb while they hold the rim 49 of the steering wheel 3.

In the example of FIG. 4 the first means 37A for detecting user inputs is associated with communications functions. The first means 37A for detecting user inputs is arranged to display one or more icons 41, 42 which may enable a driver 5 to control telephone calls or other communications. The telephone calls or other communications may be placed by a cellular telephone or other communications device within the vehicle 1. The first means 37A for detecting user inputs is arranged to display a first icon 41 and a second icon 42. The first icon 41 depicts a telephone in use and may be associated with the function of accepting an incoming call. The second icon 42 depicts a telephone not in use and may be associated with the function of rejecting an incoming call or terminating an incoming call.

In the example of FIG. 4 the second means 37B for detecting user inputs is associated with a different function to the first means 37A for detecting user inputs. In the example of FIG. 4 the second means 37B for detecting user inputs is associated with entertainment functions. The second means 37B for detecting user inputs may be arranged to enable the driver to select audio content or radio stations or any other entertainment functions.

The second means 37B for detecting user inputs may be arranged to display a third icon 43 and a fourth icon 44. The third icon 43 depicts a plurality of arrows and may be associated with the function of navigating through a menu structure. This may enable the driver 5 to navigate through a menu of audio content selections and may enable the driver 5 to select the audio content once it has been located within the menu. The fourth icon 44 depicts a plurality of arrows and may enable the driver 5 to rewind, forward or play audio content depending on which arrow the driver 5 actuates.

In some examples the function that is performed when the user actuates an icon 41, 42, 43, 44 may depend on the gesture that the driver 5 uses to actuate the icon 41, 42, 43, 44. For instance, if the driver 5 makes a short press gesture then a first function may be performed while if the driver 5 makes a long press gesture then a second different function would be performed. As an example, in the user interface 35 of FIG. 4 the driver 5 could make a short press gesture on the forward arrow to forward through a section of audio content and could make a long press gesture on the forward arrow to skip to the next item of audio content.

It is to be appreciated that the icons 41, 42, 43, 44 illustrated in FIG. 4 are examples and that other icons 41, 42, 43, 44 could be used in other embodiments of the invention.

In some examples no information needs to be displayed on the respective means 37A, 37B for detecting user inputs. In some examples the functions associated with the respective means 37A, 37B for detecting user inputs could be indicated on a display such as the display 45 in the dashboard or a head up display unit. In some examples the respective means 37A, 37B for detecting user inputs may always be associated with the same functions so no indication of the function might be needed.

In the example user interface 35 of FIG. 4 some of the means 37 for detecting user inputs are located on the rear of the steering wheel 3. In the example of FIG. 4 two means 37 for detecting user inputs are located on the rear of the steering wheel 3. In the example of FIG. 4 a third means 37C for detecting user inputs is located on the left hand side of the rear of the steering wheel 3 and a second means 37D for detecting user inputs is located on the right hand side of the rear of the steering wheel 3.

As the third means 37C for detecting user inputs and the fourth means 37D for detecting user inputs are located on the rear of the steering wheel 3 they are not viewed by the driver 5. The third means 37C for detecting user inputs and the fourth means 37D for detecting user inputs are not shown in FIG. 4 which shows the view of the user interface 5 that a driver 5 would have. FIG. 5 schematically illustrates a cross section through a steering wheel 3 that indicates the relative positions of the plurality means 37 for detecting user inputs.

As the third means 37C for detecting user inputs and the fourth means 37D for detecting user inputs are located on the rear of the steering wheel 3 there would be no need to display any information on these means 37C, 37D for detecting user inputs. In such examples information indicative of the functions associated with these means 37C, 37D for detecting user inputs may be displayed in other locations for instance it may be displayed on the display 45 within the dashboard or in any other suitable location. In some examples information indicative of the functions associated with the means 37C, 37D for detecting user inputs on the rear of the steering wheel 3 could be displayed on front of the steering wheel 3.

The third means 37C for detecting user inputs and the fourth means 37D for detecting user inputs may be located on the rear of the steering wheel 3 so that they can be actuated by the driver 5 when the driver 5 is holding the rim 49 of the steering wheel 3. In such examples third means 37C for detecting user inputs and the fourth means 37D for detecting user inputs may be positioned to enable the driver 5 to make gesture user inputs with their fingers when they are holding the rim 49 of the steering wheel 3. The third means 37C for detecting user inputs and the fourth means 37D for detecting user inputs may be arranged to detect multiple fingers simultaneously. This may enable multi-touch inputs to be registered.

In the example user interface 35 of FIG. 4 the means 37 for detecting user inputs located on the steering wheel 3 are arranged to rotate about the steering column axis. The means 37 for detecting user inputs are fixed in position relative to the steering wheel 3. In the example of FIG. 4 the means 37 for detecting the user inputs are positioned on spokes 46 of the steering wheel 3. This ensures that the driver 5 can still easily actuate the means 37 for detecting user inputs when they are turning the steering wheel 3.

In some examples the apparatus 11 may be configured to detect the angle through which the steering wheel 3 has been rotated. If it is determined that the steering wheel 3 has been rotated though an angle greater than a threshold angle then the apparatus 11 may disable the means 37 for detecting user inputs. Additionally or alternatively, the apparatus 11 may be configured to detect the rate of change of the angular position of the steering wheel 3. If it is determined that the steering wheel 3 has been/is being rotated at a rate greater than a threshold rate, then the apparatus 11 may disable the means 37 for detecting user inputs. This may prevent the driver 5 from accidentally actuating the means 37 for detecting user inputs when they are performing manoeuvers such as parking the vehicle 1.

The apparatus 11 may also be arranged to re-enable the means 37 for detecting user inputs so that the user interface 35 is only locked temporarily. In some examples the apparatus 11 may be arranged to unlock the means 37 for detecting user inputs after the manoeuver has been completed. In such examples the apparatus 11 may detect that the steering wheel 3 has been returned to a predetermined orientation or that a threshold time has passed since the means 37 for detecting user inputs was disabled.

In the example of FIG. 4 the user interface 35 also comprises a display 45. The display 45 comprises means for providing information to the driver 5. The display 45 may be located in the dashboard. The display 45 is positioned in front of the driver 5 so that the driver 5 may view information displayed on the display 45.

Any suitable information may be displayed on the display 45. The display 45 may be configured to display information relating to the driving of the vehicle 1 such as the speed, rev count and fuel levels. The display 45 may also be arranged to display other information which may be associated with the means 37 for detecting user inputs. For instance in some examples the display 45 may display information indicative of the functions associated with the respective means 37 for detecting user inputs. In such examples a function or icon may be displayed on the display 45 together with an indication of which of the plurality of means 37 for detecting a user input is associated with the function or icon.

In some examples user interface 35 may be configured to enable the driver 5 to use one or more of the means 37 for detecting a user input to control the information that is displayed on the display 45. For instance, if the driver 45 is using the means 37 for detecting a user input to navigate through a menu the menu structure may be displayed on the display 45. In some examples the display 45 may be configured to display information such as a map. The user interface 35 may enable the driver 5 to use the means 37 for detecting a user input to control the map on the display 45. For instance the driver 5 may make user inputs which causes zooming in or out of the map or changing the map, changing the format of the map or making any other suitable interactions with the map.

It is to be appreciated that other types of information may be displayed on the display 45 in other examples of the disclosure and other types of interaction with the information may be performed.

FIG. 5 schematically illustrates a cross section through the line X-X of the steering wheel 3 of FIG. 4. This shows the means 37A, 37B for detecting user inputs on the front of the steering wheel 3 and also the means 37C, 37D for detecting user inputs on the rear of the steering wheel 3.

In the example of FIG. 5 the means 37A, 37B for detecting user inputs on the front of the steering wheel 3 comprise sensors 51 on the surface 53 of the means 37A, 37B for detecting user inputs. The sensors 51 could comprise any suitable types of sensors such as capacitive or resistive sensors which may be arranged to detect the driver touching the surface 53 of the means 37A, 37B for detecting user inputs.

In the example of FIG. 5 the means 37C, 37D for detecting user inputs on the rear of the steering wheel 3 may comprise infrared sensor devices. In such examples the means 37C, 37D for detecting user inputs comprises a source 57 of infrared light and sensor 55. The sensor 55 is arranged to detect the infrared light emitted by the source 53.

In the example of FIG. 5 the source 57 is positioned in the center of the steering wheel 3. The source 57 may be positioned on the column of the steering wheel 3. The sensor 55 is positioned in the rim 49 of the steering wheel 3. In these examples if the driver 5 places a finger or other digit between the source 57 and the sensor 55 this will block the infrared light. The sensor 55 can provide a signal indicating that the infrared light has been blocked and so enable an apparatus 11 to detect a user input.

In other examples the source 57 and the sensor 55 may be positioned adjacent to each other. For instance, both the source 57 and the sensor 55 could be positioned on the column of the steering wheel 3. In such examples if the driver 5 places a finger or other digit on the rear of the steering wheel 3 this will reflect infrared light back towards the sensor 55. The sensor 55 can then provide a signal indicating that infrared light has been detected and so enables an apparatus 11 to detect a user input.

In the above described examples different types of means 37 for detecting user inputs have been provided within the same user interface 35. In other examples all of the means 37 for detecting user inputs may be the same type.

FIG. 6 illustrates an example method. The method may be implemented using example apparatus 11 and systems 33 as described above.

The method comprises, at block 61, detecting a combination user input. The combination user input comprises a first gesture input detected by a first means 37A for detecting user inputs and a second gesture input detected by a second means 37B for detecting user inputs. The first means 37A for detecting user inputs and the second means 37B for detecting user inputs are provided on a steering wheel 41 of the vehicle 1.

The apparatus 11 may be arranged to detect the combination user input. The apparatus 11 may detect the combination user input by receiving a first signal from a first means 37A for detecting user inputs indicative of a first gesture input and receiving a second signal from a second means 37B for detecting user inputs and recognizing the two gesture user inputs as a combination user input.

In some examples the first gesture input and the second gesture input may be detected simultaneously. In such examples the driver 5 may actuate different means 37 for detecting user inputs at the same time. In other examples the first gesture input and the second gesture input may be detected sequentially. In such examples the driver 5 may actuate different means 37 for detecting user inputs one after the other. The driver 5 may actuate the different means 37 for detecting user inputs so that only a short period of time occurs between the different user inputs.

The method also comprises, at block 63, enabling a function associated with the combination user input to be performed. In some examples the apparatus 11 may perform the function. In some examples the apparatus 11 may send a control signal to another apparatus or system to enable the function to be performed.

The method of FIG. 6 enables a plurality of different means 37 for detecting user inputs to be used to detect multi-touch inputs. This may provide for a versatile and intuitive user interface 35. The number of functions that may be enabled through the user interface 35 can be increased by increasing the number and type of different user inputs that can be detected. A different combination user input may be registered this provides a scalable user interface 35 than may be arranged to access any number of functions and applications.

The use of combination user inputs may reduce the likelihood of a driver 5 accidentally actuating the means 37 for detecting user inputs. The driver 5 may be less likely to accidentally actuate two or more means 37 for detecting user inputs than to accidentally actuate one of the means 37 for detecting user inputs.

It is to be appreciated that any two or more of the plurality of means 37 for detecting user inputs could be used. For instance in some examples the combination user input may involve the two means 37A, 37B for detecting user inputs that are provided on the front of the steering wheel 3. In such examples the driver 5 could use both of their thumbs to make swiping gestures. The swiping gestures could change the information that is displayed on the display 45 by zooming or navigating through a menu or enable any other suitable function.

In some examples the combination user input may involve the two means 37C, 37D for detecting user inputs that are provided on the rear of the steering wheel 3. In such examples the driver 5 could use the fingers of both of their hands 47, 48 to make swiping gestures. The swiping gestures could change the information that is displayed on the display 45 by zooming or navigating through a menu or enable any other suitable function.

In some examples the combination user input may involve a means 37A, for detecting user inputs that is provided on the front of the steering wheel 3 and a means 37C for detecting user inputs that is located on the rear of the steering wheel 3. In such examples the combination user input could comprise a pinching motion comprising movement of a finger and a thumb of the same hand 47. The pinching motion could enable the driver 5 to select an item from a menu or select an icon displayed on a display 45 or any other suitable function.

The function that is enabled by the apparatus 11 may be dependent on the current mode of operation of the user interface 35. The user interface 35 may be arranged in different modes of operation to enable access to different functions and applications within the vehicle 1.

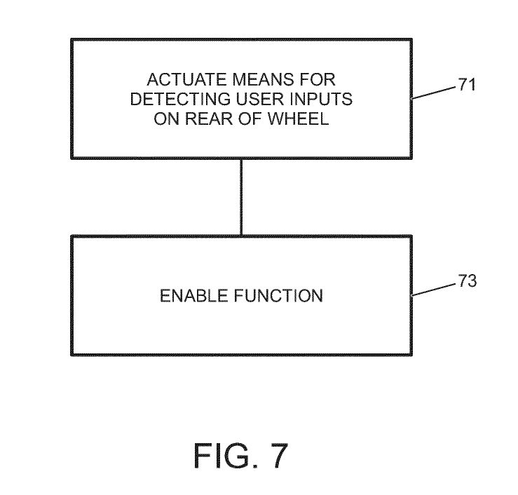

FIG. 7 illustrates another example method. The example method of FIG. 7 may also be implemented using example apparatus 11 and systems 33 as described above.

The method comprises, at block 71 detecting a gesture user input wherein the gesture user input comprises a user actuating a means 37C, 37D for detecting user inputs located on the rear of a steering wheel 3.

The apparatus 11 may be arranged to detect the gesture user input. The apparatus 11 may detect the gesture user input by receiving a signal means 37C, 37D for detecting user inputs located on the rear of a steering wheel 3 and recognizing the gesture inputs.

The driver 5 may make any suitable gesture to actuate the means 37C, 37D for detecting user inputs located on the rear of a steering wheel 3. The driver 5 may make the gesture with their fingers while they hold the rim 49 of the steering wheel 3. This may enable the driver 5 to make user inputs without having to take their hands 47, 48 off the steering wheel 3.

The gesture user input could comprise the driver 5 tapping the rear of the steering wheel 3 the driver 5 moving one or more of their fingers or any other suitable gesture user input. The gesture user input could be made using one digit or a plurality of digits.

In the method of FIG. 7 the driver 5 may use their fingers to make the user inputs. The range of movement and dexterity of the fingers may be greater than that for the thumbs. This may make such user inputs easier for the driver 5 to make. This may also increase the number and type of different user inputs that are available.

The method also comprises at block 73 enabling a function associated with gesture user input to be performed.

The function that is to be performed may depend on the mode of operation of the user interface 35. In some examples information indicative of the function that is to be performed may be displayed to the driver 5. In some examples the information indicative of the function to be performed could be displayed on the front of the steering wheel 3. In other examples information indicative of the function to be performed could be displayed in the display 45 in the dashboard or in any other suitable location.

The blocks illustrated in the FIGS. 6 and 7 may represent steps in a method and/or sections of code in the computer program 27. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of detecting user inputs for controlling a vehicle, the method comprising:
detecting a combination user input where the combination user input comprises a first gesture input detected by a first user input device and a second gesture input detected by a second user input device, wherein the first user input device and the second user input device are provided on a steering wheel of the vehicle;
enabling a function associated with the combination user input to be performed; and
disabling at least one of the user input devices if it is detected that the steering wheel has been rotated at a rate greater than a threshold rate.

2. The method as claimed in claim 1, wherein the first gesture input and the second gesture input are detected simultaneously or sequentially.

3. (canceled)

4. The method as claimed in claim 1, wherein at least one of the user input devices is located on a front of the steering wheel and/or on a rear of the steering wheel.

5. (canceled)

6. The method as claimed claim 1, wherein at least one of the user input devices is located on the steering wheel and arranged to rotate about a steering column axis.

7. The method as claimed in claim 6, further comprising disabling at least one of the user input devices if it is detected that the steering wheel has been rotated though an angle greater than a threshold angle.

8. The method as claimed in claim 1, wherein the function that is enabled is dependent on a current mode of operation of a user interface.

9. The method as claimed in claim 1, wherein the function that is enabled comprises controlling information displayed on a display and/or navigating through a menu structure.

10. (canceled)

11. The method as claimed in claim 1, wherein at least one of the user input devices comprises a touch sensitive device and/or an infrared sensor device.

12. (canceled)

13. An apparatus for detecting user inputs for controlling a vehicle, the apparatus comprising an electronic processor comprising:
an electrical input configured to receive, from a first user input device provided on a steering'wheel of the vehicle, a signal indicating a first gesture input detected by the first user input device;
an electrical input configured to receive, from a second user input device provided on the steering wheel of the vehicle, a signal indicating a second gesture input detected by the second user input device; and
an electronic memory device electrically coupled to the electronic processor and having instructions stored therein,
wherein the processor is configured to access the memory device and execute the instructions stored therein such that it is operable to:
determine a combination user input, where the combination user input comprises the first gesture input and the second gesture input;
command control of a function of the vehicle by enabling a function associated with the combination user input to be performed; and
disable at least one of the user input devices if it is detected that the steering wheel has been rotated at a rate greater than a threshold rate.

14. The apparatus as claimed in claim 13, wherein the processor is arranged to determine whether the first gesture input and the second gesture were input simultaneously.

15. The apparatus as claimed in claim 13, wherein the processor is arranged to determine whether the first gesture input and the second gesture were input sequentially.

16. The apparatus as claimed in claim 13, wherein at least one of the user input devices is located on a front of the steering wheel, and/or wherein at least one of the user input devices is located on a rear of the steering wheel.

17. (canceled)

18. The apparatus as claimed in claim 13, wherein at least one of the user input devices is located on the steering wheel and arranged to rotate about a steering column axis.

19. The apparatus as claimed in claim 18, wherein the processor is arranged to disable at least one of the user input devices if it is detected that the steering wheel has been rotated though an angle greater than a threshold angle.

20. The apparatus as claimed in claim 13, wherein the function that is enabled is dependent on a current mode of operation of a user interface.

21. The apparatus as claimed in 13, wherein the function that is enabled comprises controlling information displayed on a display and/or navigating through a menu structure.

22. (canceled)

23. The apparatus as claimed in claim 13, wherein at least one of the user input devices comprises a touch sensitive device and/or an infrared sensor device.

24. (canceled)

25. A vehicle comprising the apparatus as claimed in claim 13.

26. A computer program product, comprising a non-transitory computer readable storage medium having encoded thereon instructions that, when executed by one or more processors, causes the one or more processors to perform, at least:
detecting a combination user input where the combination user input comprises a first gesture input detected by a first user input device and a second gesture input detected by a second user input device, wherein the first user input device and the second user input device are provided on a steering wheel of a vehicle; and
enabling a function associated with the combination user input to be performed.

27-28. (canceled)
